(19) United States
(12) Patent Application Publication
(10) Pub. No.: US 2012/0262364 A1
(43) Pub. Date: Oct. 18, 2012

(54) LIQUID CRYSTAL DRIVE CIRCUIT, LIQUID CRYSTAL DISPLAY DEVICE PROVIDED THEREWITH, AND DRIVE METHOD FOR LIQUID CRYSTAL DRIVE CIRCUIT

(75) Inventors: Shohei Katsuta, Osaka-shi (JP); Tetsuya Ide, Osaka-shi (JP); Seiji Ohhashi, Osaka-shi (JP)

(73) Assignee: SHARP KABUSHIKI KAISHA, Osaka-shi, Osaka (JP)

(21) Appl. No.: 13/517,063

(22) PCT Filed: Sep. 30, 2010
(86) PCT No.: PCT/JP2010/067104

§ 371 Date: Jun. 19, 2012

(30) Foreign Application Priority Data
Dec. 21, 2009 (JP) 2009-289525

(51) Int. Cl. G09G 3/36

(52) U.S. Cl. 345/92

(57) ABSTRACT

A liquid crystal drive circuit, a liquid crystal display device, and a method for driving the liquid crystal drive circuit are disclosed. A liquid crystal drive circuit of an embodiment includes: a gate bus line drive circuit for driving a plurality of gate bus lines; a drive parameter selecting section for selecting, in accordance with how many gate bus lines of the plurality of gate bus lines are concurrently driven by the gate bus line drive circuit, a drive parameter optimized for a ratio between bright and dark pixels which ratio is determined in accordance with how many gate bus lines of the plurality of gate bus lines are concurrently driven by the drive parameter selecting section; and a source bus line drive circuit for driving a plurality of source bus lines by use of the drive parameter thus selected by the drive parameter selecting section.

### TECHNICAL FIELD

The present invention relates to (i) a liquid crystal drive circuit for use in a display section of an electronic device or the like, (ii) a liquid crystal display device including the liquid crystal drive circuit, and (iii) a method for driving the liquid crystal drive circuit.

### BACKGROUND ART

A liquid crystal display device including a liquid crystal driving circuit has been in widespread use in a monitor device of a television receiver or a personal computer, and the like. The liquid crystal display device that is in such widespread use is required to have a high viewing angle characteristic such that a display screen can be viewed from any direction. A display screen with a low viewing angle characteristic has a problem such that, in a case where a display screen is viewed from an oblique direction, a luminance difference within an effective driving voltage range is decreased. This phenomenon is most noticeable in a color change. For example, in a case where a display screen is viewed from an oblique direction, an image displayed is viewed whiter than in a case where the display screen is viewed from a front direction. As a countermeasure to such a phenomenon, an art described below is available in which a wide viewing angle characteristic can be secured.

A patent literature 1 discloses a liquid crystal display device substrate including pixel regions in each of which (i) a first sub pixel having a first pixel electrode connected to a first transistor and (ii) a second sub pixel having a second pixel electrode connected to a second transistor are provided, the second pixel electrode of the second sub pixel being connected also to a third transistor. The third transistor is electrically connected to a gate bus line provided next to a gate bus line to which a gate electrode of the second transistor is connected. The liquid crystal display device substrate can cause a difference between an applied voltage across the first sub pixel and an applied voltage across the second sub pixel. This makes it possible to provide a liquid crystal display device having a good display characteristic, especially a wide viewing angle characteristic.

### CITATION LIST

### Patent Literature

Patent Literature 1

Japanese Patent Application Publication, Tokukai, No. 2006-133577 A (Publication Date: May 25, 2006)

### SUMMARY OF INVENTION

### Technical Problem

A liquid crystal display device capable of carrying out 3D display has been in widespread use. The liquid crystal display device carries out 3D display in accordance with a time-division method by causing an image for a right eye and an image for a left eye to be alternately displayed. This requires the liquid crystal display device to be subjected to 120 Hz driving whose driving speed is twice as high as a driving speed at which the liquid crystal display device is normally driven. However, the 120 Hz driving is insufficient to secure a good display quality. As such, the liquid crystal display device which carries out 3D display in accordance with the time-division method is required to be subjected to driving at a high speed of at least not less than 240 Hz.

A method for realizing 240 Hz driving by use of a liquid crystal display device substrate of a liquid crystal panel subjected to 120 Hz driving is exemplified by a method for concurrently supplying scanning signals to respective two gate bus lines. According to the method, for example, in order to drive a liquid crystal display panel including 1080 gate bus lines, it is possible to supply signals to respective all of the 1080 gate bus lines in a time conventionally required to supply scanning signals to respective 540 gate bus lines. That is, the driving speed is doubled so that 240 Hz driving can be realized. The method requires a gate driver that concurrently supplies scanning signals to respective two gate bus lines. However, the method requires no significant modification to an arrangement of the liquid crystal panel. This makes it possible to realize high speed driving of the liquid crystal display device by requiring only a minimum cost increase.

However, the art described in the patent literature 1 causes a problem described below in a case where scanning signals are to be concurrently supplied to respective two gate bus lines.

The liquid crystal display device substrate of the patent literature 1 is arranged as below. A gate bus line is selected so that an electric charge is stored. Then, after a time interval, another gate bus line provided next to the gate bus line is selected so that the third transistor is turned on. This causes electric charge redistribution so that a voltage difference is caused between two sub pixels. In contrast, in a case where a plurality of gate bus lines are concurrently selected, for example, the nth gate bus line and the (n+1)^{th} gate bus line are concurrently selected, the n^{th} gate bus line and the (n+1)^{th} gate bus line are concurrently selected with no time interval. As such, a pixel and an electric redistribution capacitor are concurrently electrically charged. This prevents electric charge redistribution so that no voltage difference is caused between two sub pixels. This prevents improvement in display characteristic such as a viewing angle characteristic.

The present invention is made in view of the problem, and an object of the present invention is to provide a liquid crystal drive circuit, a liquid crystal display device including the liquid crystal drive circuit, and a method for driving the liquid crystal drive circuit, each of which is capable of achieving both high speed driving and an improvement in display characteristic such as viewing angle characteristic by requiring only a minimum cost increase.

### Solution To Problem

In order to attain the object, a liquid crystal drive circuit of the present invention for driving a liquid crystal display device substrate, includes: a plurality of gate bus lines provided so as to be juxtaposed to each other on a substrate; a plurality of source bus lines provided so as to intersect with the plurality of gate bus lines, via an insulating film; a plurality of storage capacitor bus lines provided so as to be juxtaposed to the respective plurality of gate bus lines; each pixel region, in which a first sub pixel having a first pixel electrode and a second sub pixel having a second pixel electrode are provided and which is specified by one source bus line and one gate bus line, including: a first transistor, having (a) a gate electrode electrically connected to the one gate bus line, (b) a source electrode electrically connected to the one source bus line, and (c) a drain electrode electrically connected to the first pixel electrode, a second transistor, having (a′) a gate electrode electrically connected to the one gate bus line, (b′) a source electrode electrically connected to the one source bus line, and (c′) a drain electrode electrically connected to the second pixel electrode which is electrically isolated from the first pixel electrode; a third transistor, having (a″) a gate electrode electrically connected to another gate bus line provided next to the one gate bus line and (b″) a drain electrode electrically connected to the second pixel electrode; a buffer capacitor section, having (a″′) a first buffer capacitor electrode electrically connected to a storage capacitor bus line and (b″′) a second buffer capacitor electrode provided so as to face the first buffer capacitor electrode via the insulating film and electrically connected to a source electrode of the third transistor; gate bus line driving means for driving the plurality of gate bus lines; drive parameter selecting means for selecting, in accordance with how many gate bus lines of the plurality of gate bus lines are concurrently driven by the gate bus line driving means, a drive parameter optimized for a ratio between bright and dark pixels which ratio is determined in accordance with how many gate bus lines of the plurality of gate bus lines are concurrently driven by the gate bus line driving means; and source bus line driving means for driving the plurality of source bus lines by use of the drive parameter thus selected by the drive parameter selecting means.

According to the configuration, the drive parameter selecting means of the liquid crystal driving circuit of the present invention selects, in accordance with how many of gate bus lines of the plurality of gate bus lines are concurrently driven, a drive parameter optimized for a ratio between bright and dark pixels which ratio is determined in accordance with how many gate bus lines of the plurality of gate bus lines are concurrently driven. Then, the source bus line driving means drives the plurality of source bus lines by use of the drive parameter selected by the drive parameter selecting means.

That is, in a mode in which two or more of the plurality of gate bus lines are concurrently driven, the liquid crystal drive circuit can concurrently drive the plurality of source bus lines by use of the drive parameter optimized for a ratio between bright and dark pixels which ratio is determined in accordance with how many of the plurality of gate bus lines are concurrently driven. According to this, even in a case where the liquid crystal drive circuit is driven in a high speed drive mode in which two or more of the plurality of gate bus lines are concurrently driven, a gray scale-luminance characteristic can be close to a gray scale-luminance characteristic obtained in a mode in which the plurality of gate bus lines are sequentially driven. As such, a display characteristic such as a viewing angle characteristic can be improved in the high speed drive mode. Further, it is possible to carry out 240 Hz driving with respect to the liquid crystal drive circuit by use of a liquid crystal display device substrate of a liquid crystal panel which is subjected to 120 Hz driving. Therefore, it is unnecessary to significantly modify an arrangement of the liquid crystal panel. This makes it possible to realize high speed driving of the liquid crystal drive circuit by requiring only a minimum cost increase.

In view of the above description, the liquid crystal drive circuit brings about an effect of achieving both the high speed driving and the improvement in display characteristic such as the viewing angle characteristic by requiring only a minimum cost increase.

In order to attain the object, a method of the present invention for driving a liquid crystal driving circuit for driving a liquid crystal display device substrate, including: a plurality of gate bus lines provided so as to be juxtaposed to each other on a substrate; a plurality of source bus lines provided so as to intersect with the plurality of gate bus lines, via an insulating film; a plurality of storage capacitor bus lines provided so as to be juxtaposed to the respective plurality of gate bus lines; each pixel region, in which a first sub pixel having a first pixel electrode and a second sub pixel having a second pixel electrode are provided and which is specified by one source bus line and one gate bus line, including: a first transistor, having (a) a gate electrode electrically connected to the one gate bus line, (b) a source electrode electrically connected to the one source bus line, and (c) a drain electrode electrically connected to the first pixel electrode, a second transistor, having (a′) a gate electrode electrically connected to the one gate bus line, (b′) a source electrode electrically connected to the one source bus line, and (c′) a drain electrode electrically connected to the second pixel electrode which is electrically isolated from the first pixel electrode; a third transistor, having (a″) a gate electrode electrically connected to another gate bus line provided next to the one gate bus line and (b″) a drain electrode electrically connected to the second pixel electrode; and a buffer capacitor section, having (a′″) a first buffer capacitor electrode electrically connected to a storage capacitor bus line and (b′″) a second buffer capacitor electrode provided so as to face the first buffer capacitor electrode via the insulating film and electrically connected to a source electrode of the third transistor, the method includes the steps of: (i) driving the plurality of gate bus lines; (ii) selecting, in accordance with how many gate bus lines of the plurality of gate bus lines are concurrently driven in the step (i), a drive parameter optimized for a ratio between bright and dark pixels which ratio is determined in accordance with how many gate bus lines of the plurality of gate bus lines are concurrently driven in the step (i); and (iii) driving the plurality of source bus lines by use of the drive parameter thus selected in the step (ii)

The configuration brings about an advantageous effect similar to that brought about by the liquid crystal drive circuit of the present invention.

The scope of the present invention also encompasses a liquid crystal display device including the liquid crystal drive circuit.

For a fuller understanding of the nature and advantages of the invention, reference should be made to the ensuing detailed description taken in conjunction with the accompanying drawings.

### Advantageous Effects of Invention

As described earlier, a liquid crystal driving circuit of the present invention for driving a liquid crystal display device substrate, includes: a plurality of gate bus lines provided so as to be juxtaposed to each other on a substrate; a plurality of source bus lines provided so as to intersect with the plurality of gate bus lines, via an insulating film; a plurality of storage capacitor bus lines provided so as to be juxtaposed to the respective plurality of gate bus lines; each pixel region, in which a first sub pixel having a first pixel electrode and a second sub pixel having a second pixel electrode are provided and which is specified by one source bus line and one gate bus line, including: a first transistor, having (a) a gate electrode electrically connected to the one gate bus line, (b) a source electrode electrically connected to the one source bus line, and (c) a drain electrode electrically connected to the first pixel electrode, a second transistor, having (a′) a gate electrode electrically connected to the one gate bus line, (b′) a source electrode electrically connected to the one source bus line, and (c′) a drain electrode electrically connected to the second pixel electrode which is electrically isolated from the first pixel electrode; a third transistor, having (a″) a gate electrode electrically connected to another gate bus line provided next to the one gate bus line and (b″) a drain electrode electrically connected to the second pixel electrode; a buffer capacitor section, having (a″′) a first buffer capacitor electrode electrically connected to a storage capacitor bus line and (b″′) a second buffer capacitor electrode provided so as to face the first buffer capacitor electrode via the insulating film and electrically connected to a source electrode of the third transistor; gate bus line driving means for driving the plurality of gate bus lines; drive parameter selecting means for selecting, in accordance with how many gate bus lines of the plurality of gate bus lines are concurrently driven by the gate bus line driving means, a drive parameter optimized for a ratio between bright and dark pixels which ratio is determined in accordance with how many gate bus lines of the plurality of gate bus lines are concurrently driven by the gate bus line driving means; and source bus line driving means for driving the plurality of source bus lines by use of the drive parameter thus selected by the drive parameter selecting means. This makes it possible to achieve both high speed driving and an improvement in display characteristic such as a viewing angle characteristic by requiring only a minimum cost increase.

A method of the present invention for driving a liquid crystal driving circuit for driving a liquid crystal display device substrate, including: a plurality of gate bus lines provided so as to be juxtaposed to each other on a substrate; a plurality of source bus lines provided so as to intersect with the plurality of gate bus lines, via an insulating film; a plurality of storage capacitor bus lines provided so as to be juxtaposed to the respective plurality of gate bus lines; each pixel region, in which a first sub pixel having a first pixel electrode and a second sub pixel having a second pixel electrode are provided and which is specified by one source bus line and one gate bus line, including: a first transistor, having (a) a gate electrode electrically connected to the one gate bus line, (b) a source electrode electrically connected to the one source bus line, and (c) a drain electrode electrically connected to the first pixel electrode, a second transistor, having (a′) a gate electrode electrically connected to the one gate bus line, (b′) a source electrode electrically connected to the one source bus line, and (c′) a drain electrode electrically connected to the second pixel electrode which is electrically isolated from the first pixel electrode; a third transistor, having (a″) a gate electrode electrically connected to another gate bus line provided next to the one gate bus line and (b″) a drain electrode electrically connected to the second pixel electrode; and a buffer capacitor section, having (a″′) a first buffer capacitor electrode electrically connected to a storage capacitor bus line and (b″′) a second buffer capacitor electrode provided so as to face the first buffer capacitor electrode via the insulating film and electrically connected to a source electrode of the third transistor, the method includes the steps of: (i) driving the plurality of gate bus lines; (ii) selecting, in accordance with how many gate bus lines of the plurality of gate bus lines are concurrently driven in the step (i), a drive parameter optimized for a ratio between bright and dark pixels which ratio is determined in accordance with how many gate bus lines of the plurality of gate bus lines are concurrently driven in the step (i); and (iii) driving the plurality of source bus lines by use of the drive parameter thus selected in the step (ii). This makes it possible to achieve both high speed driving and an improvement in display characteristic such as a viewing angle characteristic by requiring only a minimum cost increase.

### BRIEF DESCRIPTION OF DRAWINGS

FIG. 1

FIG. 1 is a view showing equivalent circuits of adjacent pixels in a liquid crystal driving circuit in accordance with a first embodiment of the present invention.

FIG. 2

FIG. 2 is a view schematically explaining a method for driving the liquid crystal driving circuit in accordance with the first embodiment of the present invention.

FIG. 3

FIG. 3 is a view showing an example of a lookup table in accordance with the first embodiment of the present invention.

FIG. 4

FIG. 4 is a view showing a luminance with respect to a gray scale in accordance with the first embodiment of the present invention.

FIG. 5

FIG. 5 is a view showing an example of a lookup table in accordance with a second embodiment of the present invention.

FIG. 6

FIG. 6 is a view showing a chromaticity with respect to a gray scale in accordance with the second embodiment of the present invention.

### DESCRIPTION OF EMBODIMENTS

### Embodiment 1

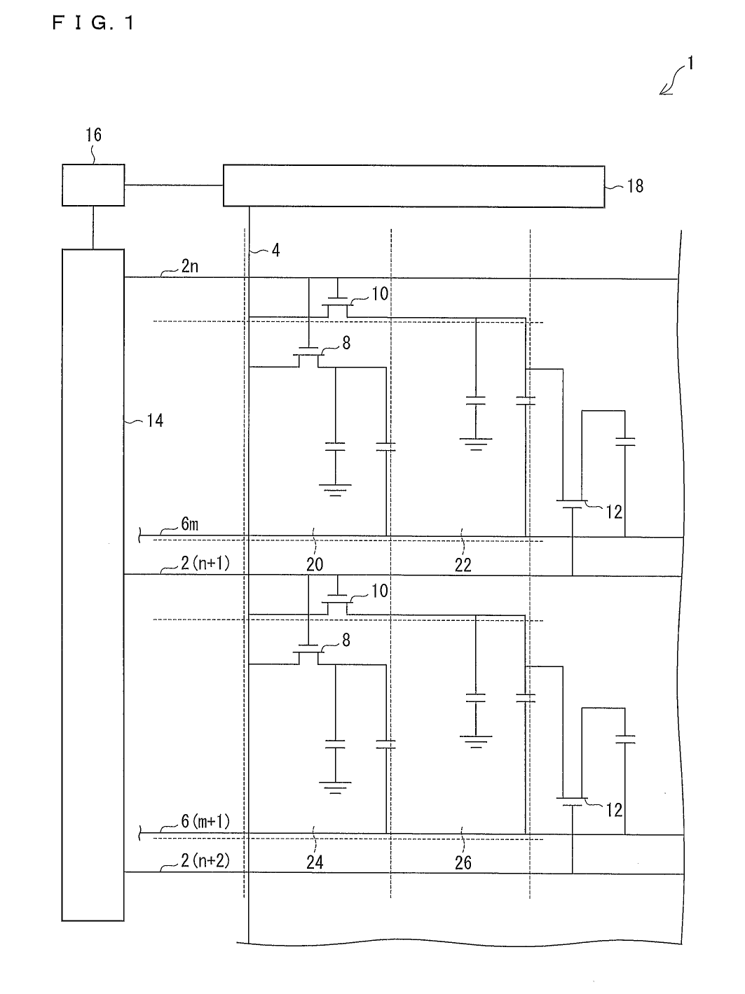

One embodiment of the present invention is described below with reference to FIGS. 1 through 4.

### Configuration of Liquid Crystal Driving Circuit 1

With reference to FIG. 1, the following description discusses how a liquid crystal driving circuit 1 included in a liquid crystal display device is configured in accordance with the present embodiment. FIG. 1 shows equivalent circuits of adjacent pixels in the liquid crystal driving circuit 1. As shown in FIG. 1, the liquid crystal driving circuit 1 includes (i) gate bus lines 2 and source bus lines 4, which are provided so as to intersect with each other via an insulating film (which is not shown), (ii) storage capacitor bus lines 6, (iii) first TFTs (thin film transistors) 8, (iv) second TFTs 10, (v) third TFTs 12, (vi) a gate bus line driving circuit 14, (vii) a drive parameter selecting section 16, and (viii) a source bus line driving circuit 18. A substrate of the liquid crystal driving circuit 1 is, for example, a TFT (thin film transistor) substrate including pixel electrodes. The liquid crystal driving circuit 1 includes (i) a counter substrate (which is not shown) on which a CF or a common electrode is provided and (ii) liquid crystals (which are not shown) which are provided between the substrate and the counter substrate and have a negative dielectric anisotropy, for example.

The gate bus lines 2 are sequentially scanned, for example. FIG. 1 shows gate bus lines 2n, 2(n+1), and 2(n+2) of the gate bus lines 2. The gate bus line 2n is the n^{th} gate bus line subjected to the n^{th} scanning, the gate bus line 2(n+1) is the (n+1)^{th} gate bus line subjected to the (n+1)^{th} scanning, and the gate bus line 2(n+2) is the (n+2)^{th} gate bus line subjected to the (n+2)^{th} scanning. In a vicinity of an intersection of a gate bus line 2 and a source bus line 4, a first TFT 8 and a second TFT 10 are provided for each pixel so as to be adjacent to each other. Parts of the gate bus line 2 serve as gate electrodes of the first TFT 8 and the second TFT 10, respectively.

An operation semiconductor layer, which is shared by the first TFT 8 and the second TFT 10, for example, is provided above the gate bus line 2 via an insulating film (which is not shown). A channel protective film, which is shared by the first TFT 8 and the second TFT 10, for example, is provided above the operation semiconductor layer. (i) A source electrode and an n-type impurity semiconductor layer provided under the source electrode and (ii) a drain electrode and an n-type impurity semiconductor layer provided under the drain electrode are provided above the channel protective film of the first TFT 8 so as to be away from each other at a given interval and face each other. Similarly, (i′) a source electrode and an n-type impurity semiconductor layer provided under the source electrode and (ii′) a drain electrode and an n-type impurity semiconductor layer provided under the drain electrode are provided above a channel protective layer of the second TFT 10 so as to be away from each other at a given interval and face each other. Each of the source electrode of the first TFT 8 and the source electrode of the second TFT 10 is electrically connected to the source bus line 4. The first TFT 8 and the second TFT 10 are juxtaposed to each other.

A storage capacitor bus line 6 extends in parallel with the gate bus line 2 so as to cross a pixel region defined by the gate bus line 2 and the source bus line 4. Storage capacitor bus lines 6m and 6(m+1) are shown in FIG. 1. The storage capacitor bus line 6m is provided between the gate bus lines 2n and 2(n+1), and the storage capacitor bus line 6(m+1) is provided between the gate bus lines 2(n+1) and 2(n+2). Although it is not shown, the each pixel includes a storage capacitor electrode provided above the storage capacitor bus line 6 via an insulating film. The storage capacitor electrode is electrically connected to the drain electrode of the first TFT 8 via a connector electrode. A first storage capacitor Cs is defined between the storage capacitor bus line 6 and the storage capacitor electrode which face each other via the insulating film. Note that the storage capacitor bus lines 6m and 6(m+1) are adjacent storage capacitor bus lines 6 as in the case of the gate bus lines 2n and 2(n+1) which are adjacent gate bus lines 2.

Furthermore, a third TFT 12 is provided in each pixel region. A gate electrode of the third TFT 12 is electrically connected to a gate bus line 2 of a second pixel provided next to a first pixel, i.e., the gate bus line 2(n+1) or 2(n+2). Although it is not shown, an operation semiconductor layer is provided above the gate electrode of the third TFT 12 via an insulating film. A channel protective film is provided above the operation semiconductor layer. (i) A source electrode and an n-type impurity semiconductor layer provided under the source electrode and (ii) a drain electrode and an n-type impurity semiconductor layer provided under the drain electrode are provided above the channel protective film so as to be away from each other at a given interval and face each other. Each of the third TFTs 12 has a drain electrode which is electrically connected via a contact hole to a pixel electrode included in a sub pixel 22 or a sub pixel 26. A first buffer capacitor electrode which is electrically connected to the storage capacitor bus line 6 via a connector electrode is provided in a vicinity of a corresponding third TFT 12 which is electrically connected to the gate bus line 2. A second buffer capacitor electrode is provided above the first buffer capacitor electrode via an insulating film. The second buffer capacitor electrode is electrically connected to the source electrode of the third TFT 12. The first and second buffer capacitor electrodes which face each other via the insulating film define a buffer capacitor Cb therebetween. The first and second buffer capacitor electrodes are collectively referred to as a buffer capacitor section.

Furthermore, the liquid crystal driving circuit 1 includes (i) the gate bus line driving circuit 14 which includes a driver IC for supplying scanning signals to the respective gate bus lines 2 and (ii) the source bus line driving circuit 18 which includes a driver IC for supplying scanning signals to the respective source bus lines 4. The gate bus line driving circuit 14 is configured so as to supply a scanning signal to a given gate bus line 2 in accordance with a given signal supplied from a control circuit (which is not shown). The source bus line driving circuit 18 is configured so as to supply a data signal to a given source bus line 4 in accordance with a given signal supplied from the control circuit.

The drive parameter selecting section 16 selects a drive parameter such as a lookup table which specifies a relationship between a gray scale of input data and an output gray scale. Then, the drive parameter selecting section 16 supplies, to the source bus line driving circuit 18, an output gray scale in accordance with the lookup table thus selected. The source bus line driving circuit 18 which has received the output gray scale applies, to the source bus line 4, a voltage corresponding to the output gray scale. Note that the drive parameter selecting section 16 does not necessarily need to have the lookup table. For example, an output gray scale may be found by calculation based on a gray scale of input data. Note, also, that the drive parameter selecting section 16 may have a function of the control circuit described above.

A first polarizing plate is provided on a surface of the liquid crystal driving circuit 1 which surface is opposite to a surface on which TFT elements are provided. A second polarizing plate is provided on a surface of the counter substrate which surface is opposite to a surface on which the common electrode is provided. The first and second polarizing plates are provided in a cross Nicols relationship. A backlight unit is provided on a side of the second polarizing plate which side is opposite to a side on which side a TFT substrate is provided.

One (1) pixel region defined by the gate bus line 2n and the gate bus line 2(n+1), and the source bus line 4 is divided into a sub pixel 20 and sub pixel 22 (see FIG. 1). For easy explanation, FIG. 1 shows the sub pixels 20 and 22 which have respective rectangular shapes. However, in reality, the sub pixel 20 has a trapezoid shape, for example, and is provided on a left side of a central part of the pixel region. The sub pixel 22 is provided in the other part of the pixel region in which part no sub pixel 20 is provided. In the pixel region, the sub pixels 20 and 22 are almost axisymmetric to each other with respect to the storage capacitor bus line 6m, for example.

The sub pixel 20 includes a first pixel electrode, and the sub pixel 22 includes a second pixel electrode electrically isolated from the first pixel electrode included in the sub pixel 20. Both of the first and second pixel electrodes are made of a transparent conductive film such as ITO. It is desirable that an area ratio of the sub pixel 22 to the sub pixel 20 be 1/2 or greater, but not greater than, 4 so that a high viewing angle characteristic can be obtained. The first pixel electrode included in the sub pixel 20 is electrically connected to each of the storage capacitor electrode and the drain electrode of the first TFT 8 via a contact hole in a protective film. The second pixel electrode included in the sub pixel 22 is electrically connected, via a contact hole in the protective film, to the drain electrode of the second TFT 10 connected to the gate bus line 2n. The second pixel electrode included in the sub pixel 22 has a region in which the second pixel electrode and the storage capacitor bus line 6m overlap with each other via the protective film and the insulating film. In this region, a second storage capacitor Cs is defined between the second pixel electrode included in the sub pixel 22 and the storage capacitor bus line 6m which face each other via the protective film and the insulating film.

Similarly, one (1) pixel region defined by the gate bus line 2(n+1) next to the gate bus line 2 and the gate bus line 2(n+2), and the source bus line 4 is also divided into a sub pixel 24 and a sub pixel 26 (see FIG. 1). Since the sub pixels and 26 are identical in arrangement to respective corresponding sub pixels 20 and 22, an explanation thereof is omitted here.

According to a conventional liquid crystal display device employing a capacitive coupling HT method, a pixel electrode included in a sub pixel 22 (sub pixel 26) is connected to a control electrode or a common electrode via a very large electric resistance. As such, it is difficult to discharge a stored electric charge. This causes a problem that relatively dark image sticking is generated in the conventional liquid crystal display device. In contrast, according to the present embodiment, the pixel electrode included in the sub pixel 22 (the sub pixel 26) is connected to the source bus line 4 via the second TFT 10. Even when the second TFT 10 is off, the operation semiconductor layer of the second TFT 10 is extremely smaller in electric resistance than the insulating film or the protective film. This allows an electric charge stored in the pixel electrode included in the sub pixel 22 (the sub pixel 26) to be easily discharged. Therefore, according to the present embodiment, no dark image sticking is caused even though a halftone method is employed.

### Summary of Method For Driving Liquid Crystal Driving Circuit 1

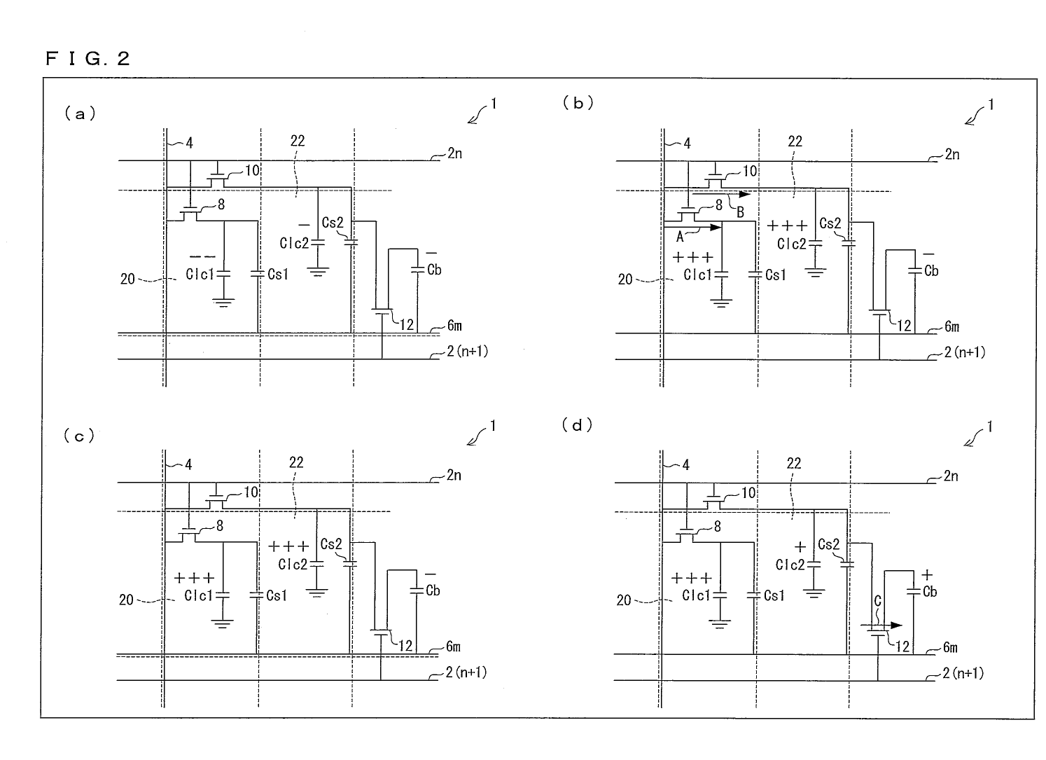

With reference to FIG. 2, the following description discusses a summary of a method for driving the liquid crystal driving circuit 1. First, a concept of electric discharging in a 3 TFT driving method is described in accordance with the present embodiment. Note that the present embodiment assumes that the liquid crystal driving circuit 1 is driven in accordance with a 3 TFT driving method. However, the present invention is not limited to this. The liquid crystal driving circuit 1 has pixel regions in each of which sub pixels 20 and 22 are provided. The sub pixel 20 includes a first pixel electrode connected to a first TFT 8 connected to a gate bus line 2n, and the sub pixel 22 includes a second pixel electrode connected to a second TFT 10. The second pixel electrode is also electrically connected to a third TFT 12 which is connected to a gate bus line 2(n+1) provided next to the gate bus line 2n to which a gate electrode of the second TFT 10 is connected.

According to the 3 TFT driving method, first, the gate bus line 2n is selected, so that an electric charge is stored in a liquid crystal capacitor Clc1 in the sub pixel 20. After a time interval, the gate bus line 2(n+1) provided next to the gate bus line 2n is selected, so that the third TFT 12 is turned on. This redistributes an electric charge stored in a liquid crystal capacitor Clc2. The redistribution of the electric charge causes a voltage difference between the liquid crystal capacitor Clc1 defined in the sub pixel 20 and the liquid crystal capacitor Clc2 defined in the sub pixel 22. This allows improvement in display characteristic such as a viewing angle characteristic.

The above description is to be discussed with reference to FIG. 2. (a) of FIG. 2 shows the liquid crystal driving circuit 1 in which a negative data signal is written in a previous frame. As shown in (a) of FIG. 2, according to the liquid crystal driving circuit 1 in which the negative data signal is written in the previous frame, the negative data signal is written to each of the liquid crystal capacitor Clc1 defined in the sub pixel 20, the liquid crystal capacitor Clc2 defined in the sub pixel 22, and a buffer capacitor Cb. In such a state, when the n^{th} gate bus line 2n (gate bus line in the nth row) is selected and the first TFT 8 and the second TFT 10 are turned on, an electric charge flows from the source line 4 to each of the liquid crystal capacitor Clc1 defined in the sub pixel 20 (see an arrow A in (b) of FIG. 2) and the liquid crystal capacitor Clc2 defined in the sub pixel 22 (see an arrow B), so that a positive data signal is written. The third TFT 12 connected to the gate bus line 2(n+1) remains off with the electric charge stored in the liquid crystal capacitors Clc1 and Clc2 defined in the respective sub pixels 20 and 22. As such, the buffer capacitor Cb is in a state in which the negative data signal has been written thereto.

(c) of FIG. 2 shows a state in which the electric charge has been stored in the above capacitors in the pixel associated with the gate bus line 2n. That is, in such a state, identical electric potentials have been written to the liquid crystal capacitors Clc1 and Clc2 defined in the respective sub pixels 20 and 22. Then, the gate bus line 2n which is not selected causes the first TFT 8 and the second TFT 10 to be turned off. After a time interval, the gate bus line 2(n+1) is selected, so that the third TFT 12 is turned on. This causes an electric charge to flow from the liquid crystal capacitor Clc2 and a storage capacitor Cs2 which are defined in the sub pixel 22 to the buffer capacitor Cb (see an arrow C in (d) of FIG. 2). That is, electric charge redistribution occurs so that each of the liquid crystal capacitor Clc2 and the storage capacitor Cs2 which are defined in the sub pixel is identical in voltage to the buffer capacitor Cb. According to a normal drive mode in which a polarity of an applied voltage (a polarity of a data signal) is reversed every frame, an electric charge having been stored in the buffer capacitor Cb and an electric charge newly flowing into the buffer capacitor Cb are opposite in polarity to each other. This reduces a total amount of electric charges stored in respective of the liquid crystal capacitor Clc2, the storage capacitor Cs2, and the buffer capacitor Cb. The reduction in total amount of the electric charges decrease voltages across respective of the liquid crystal capacitor Clc2, the storage capacitor Cs2, and the buffer capacitor Cb. However, no electric charge redistribution occurs in the sub pixel 20. As such, a voltage across the liquid crystal capacitor Clc1 defined in the sub pixel 20 does not change before and after the gate bus line 2(n+1) is selected (see (d) of FIG. 2). In view of the above description, a viewing angle characteristic can be improved by causing a difference in voltage between the liquid crystal capacitor Clc1 defined in the sub pixel 20 and the liquid crystal capacitor Clc2 defined in the sub pixel 22.

As described earlier, the electric charge stored in the liquid crystal driving circuit 1 is thus discharged since 120 Hz driving is carried out with respect to the liquid crystal driving circuit 1 so as to carry out 2D display. In contrast, in order to carry out 3D display in accordance with a time-division method, it is required to carry out high-speed 240 Hz driving with respect to the liquid crystal driving circuit 1 (described earlier). A method for carrying out the 240 Hz driving with respect to the liquid crystal driving circuit 1 which is subjected to the 120 Hz driving is exemplified by a method in which the gate bus line driving circuit 14 supplies scanning signals concurrently to respective two gate bus lines 2. This makes it unnecessary to dramatically change an arrangement of a liquid crystal panel. This makes it possible to realize high speed driving by only requiring a minimum cost increase. However, in a case where scanning signals are concurrently supplied to the respective gate bus lines 2n and 2(n+1) (see FIG. 1), the buffer capacitor Cb, i.e., a capacitor is charged while the liquid crystal capacitors Clc1 and Clc2 defined in the respective sub pixels 20 and 22 are being charged. This causes no electric charge redistribution described above. Therefore, there occurs no voltage difference between the liquid crystal capacitor Clc1 defined in the sub pixel 20 and the liquid crystal capacitor Clc2 defined in the sub pixel 22. The occurrence of no voltage difference causes both of the sub pixels 20 and 22 to be bright pixels. In this case, scanning signals are also concurrently supplied to respective of the gate bus line 2(n+2) and a gate bus line 2(n+3). That is, no scanning signals are supplied concurrently to the respective gate bus line 2(n+1) and the gate bus line 2(n+2). As such, electric charge redistribution causes a reduction in voltage of the sub pixel 26 shown in FIG. 1, so that the sub pixel 26 becomes a dark pixel.

In view of the above description, in a case (i) where scanning signals are concurrently supplied to respective two gate bus lines 2, the sub pixels 20, 22, and 24 become bright pixels and the sub pixel 26 becomes a dark pixel. That is, the bright pixels and the dark pixel are unequal in area ratio. In contrast, in a case (ii) where scanning signals are sequentially supplied to the respective gate bus lines 2, the sub pixels 20 and 24 become bright pixels and the sub pixels 22 and 26 become dark pixels, so that the bright pixels and the dark pixels are equal in area ratio of 1:1. That is, the above cases (i) and (ii) are not identical in ratio between bright and dark pixels. As such, if a lookup table for a 2D display mode in which scanning signals are sequentially supplied to the respective gate bus lines 2 is used in a 3D display mode in which scanning signals are concurrently supplied to respective two gate bus lines 2, a luminance at each gray scale in a halftone is increased. According to this, a gray scale-luminance characteristic obtained in the 3D display mode is shifted from a γ (gamma) value, e.g., γ=2.2, set in the 2D display mode in which scanning signals are sequentially supplied to the respective gate bus lines 2. This causes a deterioration in display characteristic.

In view of this, according to the liquid crystal driving circuit 1, in the case of the 3D display mode in which scanning signals are concurrently supplied to respective two gate bus lines 2, a lookup table is selected such that a gray scale-luminance characteristic in a halftone is a gray scale of halftone input data which gray scale is close to the γ (gamma) value, e.g., γ=2.2, set in the 2D display mode in which scanning signals are sequentially supplied to the respective gate bus lines 2. Then, the source bus line driving circuit 18 applies, to the source bus lines 4, a voltage in accordance with an output gray scale in the lookup table thus selected.

### Details of Driving of Liquid Crystal Driving Circuit 1

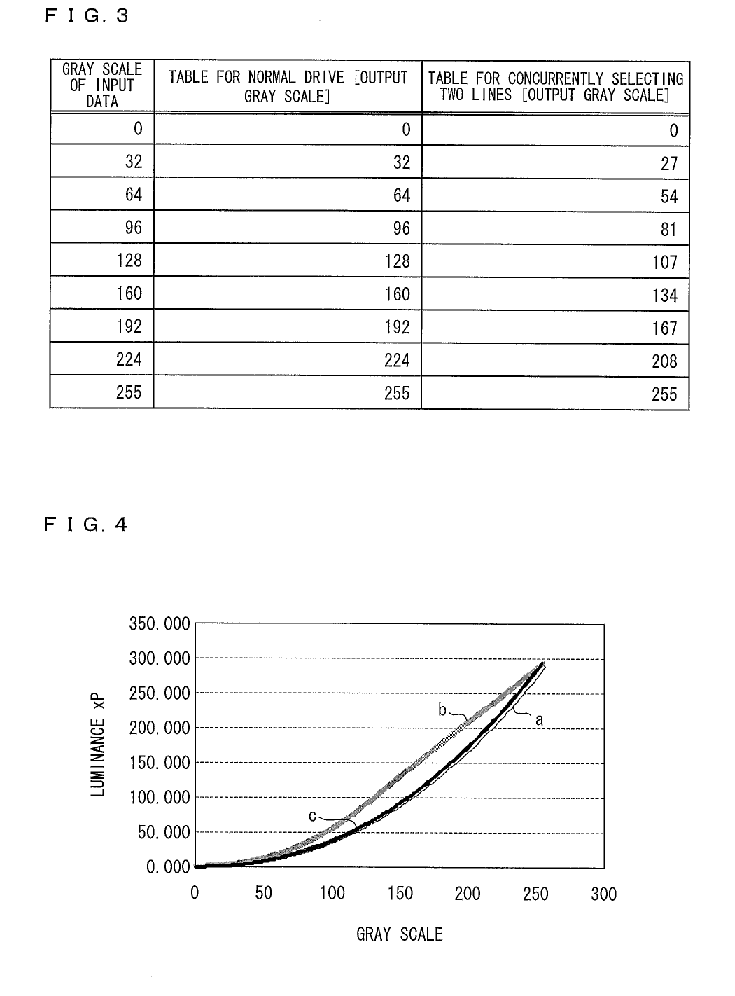

With reference to FIGS. 3 through 6, the following description discusses, in detail, the method for driving the liquid crystal driving circuit 1. FIG. 3 is a table showing output gray scales in two modes: a normal drive mode, i.e., the 2D display mode in which scanning signals are sequentially supplied to the respective gate bus lines 2, and the 3D display mode in which scanning signals are concurrently supplied to respective two gate bus lines 2. The output gray scales in the table of FIG. 3 are associated with gray scales of input data and supplied from the drive parameter selecting section 16 to the source bus line driving circuit 18. Note that, in this example, an area ratio between bright and dark pixels in the liquid crystal driving circuit 1 in the normal drive mode is 1:1, and an area ratio between bright and dark pixels in the liquid crystal driving circuit 1 in the 3D display mode is 3:1. Note that a liquid crystal panel is used such that, in a case where an ON voltage is set to 8 V, a difference in effective voltage between bright and darks pixels is 1 V and R, G, and B pixels independently display 256 gray scales.

In the case where the gate bus line driving circuit 14 supplies scanning signals concurrently to respective two gate bus lines 2, the drive parameter selecting section 16 of the liquid crystal driving circuit 1 selects a lookup table for concurrently selecting two lines (see FIG. 3). Then, in accordance with a gray scale of input video data, the drive parameter selecting section 16 determines an output gray scale of data to be supplied to the source bus line driving circuit 18. The lookup table is a drive parameter optimized for a ratio between bright and dark pixels determined in accordance with the number of concurrently selected gate bus lines 2. Then, the source bus line driving circuit 18 applies, to the gate bus lines 4, a voltage in accordance with an output gray scale selected by the drive parameter selecting section 16.

In contrast, in the normal drive mode, the drive parameter selecting section 16 selects a lookup table for the normal drive mode. Then, the source bus line driving circuit 18 applies, to the source bus line 4, a voltage in accordance with an output gray scale in the lookup table thus selected. For example, in a case where a gray scale of input data is 160, an output gray scale of 160 is obtained in the normal drive mode, whereas an output gray scale of 134 is obtained in the 3D display mode in which scanning signals are concurrently supplied to two gate bus lines 2 (see FIG. 3). The 3D display mode causes an output gray scale in a halftone gray scale to be lower than in the normal drive mode. Then, application of a voltage corresponding to an output gray scale to the source bus line 4 in accordance with an area ratio between bright and dark pixels causes a gray scale-luminance characteristic in a halftone to be close to gamma value, i.e., γ=2.2, obtained in the normal drive mode. This can improve a display characteristic even in the case of the 3D display mode, i.e., in a case where the sub pixel 22 does not become a dark pixel. For example, these two lookup tables are recorded in ROM data provided in a liquid crystal display device including the liquid crystal driving circuit 1. This allows the drive parameter selecting section 16 to select a suitable lookup table from a plurality of lookup tables recorded in the ROM data.

FIG. 4 is a view showing gray scale-luminance characteristics of the liquid crystal driving circuit 1 driven in accordance with the respective driving methods described above. A graph a shows a gray scale-luminance characteristic obtained in the normal drive mode. A graph b shows a gray scale-luminance characteristic obtained in the 3D display mode in which the lookup table for the normal drive mode is used and two gate bus lines 2 are concurrently selected. A graph c shows a gray scale-luminance characteristic obtained in the 3D display mode in which the lookup table for concurrently selecting two lines is used and two gate bus lines 2 are concurrently selected.

The graph b is shifted from the graph a showing the gray scale-luminance characteristic obtained in the normal drive mode (see FIG. 4). However, in a case where the lookup table for concurrently selecting two lines is used to concurrently select two gate bus lines 2, the graph b can be close to the graph a (see the graph c in FIG. 4). That is, it is possible to improve the gray scale-luminance characteristic. The liquid crystal display driving circuit 1 can thus improve the gray scale-luminance characteristic even in a case where two gate bus lines 2 are concurrently selected, i.e., in a case where the liquid crystal display driving circuit 1 is driven at a high speed. According to this, the liquid crystal display driving circuit 1 can have a higher display characteristic even when driven at a high speed.

According to the liquid crystal driving circuit 1, it is possible to use a lookup table which corresponds to the number of concurrently selected gate bus lines 2. For example, in a case where three gate bus lines 2 are concurrently selected, an area ratio between bright and dark pixels is 5:1. As such, a gray scale-luminance characteristic can be adjusted by applying, to the source bus line 4, a voltage in accordance with an output gray scale in a lookup table which output gray scale corresponds to the area ratio. Similarly, in a case where four gate bus lines 2 are concurrently selected, an area ratio between bright and dark pixels is 7:1. As such, a gray scale-luminance characteristic can be adjusted by applying, to the source bus line 4, a voltage in accordance with an output gray scale in a lookup table which output gray scale corresponds to the area ratio. As described earlier, according to the liquid crystal driving circuit 1, a gray scale-luminance characteristic can be close to a constant value by applying, to the gate bus line 2, a voltage in accordance with an output gray scale corresponding to the number of concurrently selected gate bus lines 2.

The drive parameter selecting section 16 includes a drive parameter for an adjustment of a gamma value, i.e., a lookup table which specifies input data gray scales and output gray scales. The lookup table specifies, for each input data gray scale, an output gray scale for each of an R (red) pixel, a G (green) pixel, and a B (blue) pixel, the output gray scale having been subjected to an adjustment of a gamma value. According to this, in a case where a gamma value needs to be adjusted, the source bus line driving circuit 18 can drive the source bus line 4 by use of a drive parameter in which the gamma value has been adjusted. As such, also in a case where a plurality of gate bus lines 2 are concurrently driven, a gamma value can be adjusted to be close to a gamma value obtained in the case where gate bus lines 2 are sequentially driven, i.e., in the case of the normal drive mode.

The drive parameter selecting section 16 includes a lookup table which specifies a drive parameter for adjustment of a color balance. The lookup table specifies, for each input data gray scale, an output gray scale for each of an R pixel, a G pixel, and a B pixel, the output gray scale having been subjected to an adjustment of a color balance. According to this, in a case where a color balance needs to be adjusted, the source bus line driving circuit 18 can drive the source bus line 4 by use of a drive parameter in which the color balance has been adjusted. As such, also in a case where a plurality of gate bus lines 2 are concurrently driven, a color balance can be adjusted to be close to a color balance obtained in the case where the gate bus lines 2 are sequentially driven, i.e., in the case of the normal drive mode. Note that the adjustment of a color balance is specifically described later.

The drive parameter selecting section 16 includes a lookup table which specifies a drive parameter for an adjustment of an overshoot value. The lookup table specifies, for each input data gray scale, an output gray scale for each of an R pixel, a G pixel, and a B pixel, the output gray scale having been subjected to an adjustment of an overshoot value. According to this, in a case where an overshoot value needs to be adjusted, the source bus line driving circuit 18 can drive the source bus line 4 by use of a drive parameter in which an overshoot value has been adjusted. This brings about a further effect of improving a response characteristic of a liquid crystal panel driven by the liquid crystal driving circuit 1, irrespectively of the number of concurrently driven gate bus lines.

### Embodiment 2

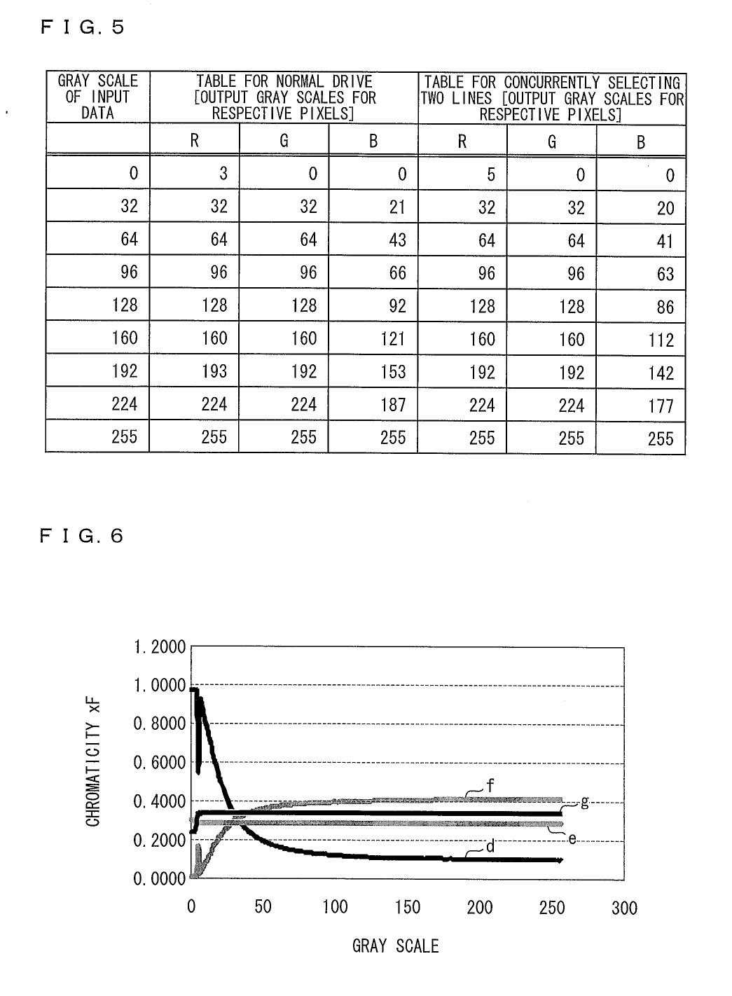

Another embodiment of the present invention, i.e., an adjustment of a color balance, is described below with reference to FIGS. 5 and 6. FIG. 5 is a lookup table which shows, for each gray scale specified by input data, gray scales, i.e., color densities of respective of an R (red) pixel, a G (green) pixel, and a B (blue) pixel, the gray scales being obtained in the case of the normal drive mode and the case where two gate bus lines 2 are concurrently selected. Note that according to the liquid crystal driving circuit 1, a halftone image can be displayed by displaying each of R, G, and B at 256 gray scales. Note, also, that, although pixel colors are R, G, and B in the present embodiment, the present invention is not limited to this. That is, it is only necessary that the pixel colors be primary colors.

In order to concurrently select two gate bus lines 2, a drive parameter selecting section 16 of the liquid crystal driving circuit 1 selects a lookup table (see FIG. 5) for concurrently selecting two lines. Then, gray scales of the respective R, G, and B pixels are determined in accordance with the lookup table thus selected. That is, an output gray scale is determined in accordance with an input data gray scale with reference to the lookup table thus selected, and the output gray scale is supplied to the source bus line driving circuit 18. Then, the source bus line driving circuit 18 applies, to respective source bus lines 4 corresponding to the respective R, G, and B pixels, voltages in accordance with output gray scales specified for the respective R, G, and B pixels.

In contrast, in the normal drive mode, the drive parameter selecting section 16 selects a lookup table (see FIG. 5) for the normal drive mode. Then, as in the case of concurrently selecting two gate bus lines 2, the source bus line driving circuit 18 applies, to respective source bus lines corresponding to the respective R, G, and B pixels, voltages in accordance with output gray scales specified for the respective R, G, and B pixels. For example, in a case where input data specifies a gray scale of 96, the drive parameter selecting section 16 selects, in accordance with the lookup table, an output gray scale of 66 for the B pixel in the normal drive mode, whereas the drive parameter selecting section 16 selects an output gray scale of 63 for the B pixel in the mode in which two gate bus lines 2 are concurrently selected (see FIG. 5). Then, the source bus line driving circuit 18 applies, to the source bus line 4, a voltage in accordance with the output gray scale of 63 thus selected.

That is, assume that gray scales of the respective of R, G, and B pixels are adjusted in accordance with an area ratio between bright and dark pixels by use of these lookup tables, In this case, even if the liquid crystal driving circuit 1 is driven in the mode in which two gate bus lines 2 are concurrently selected, an image displayed in a liquid crystal panel of a liquid crystal display device including the liquid crystal driving circuit 1 can have a chromaticity which is close to a chromaticity obtained when the liquid crystal driving circuit 1 is driven in the normal drive mode.

FIG. 6 has graphs showing gray scale-chromaticity characteristics at respective chromaticity coordinates x and y in a chromaticity diagram, the gray scale-chromaticity characteristics being obtained in a liquid crystal panel in which gray scales of respective pixels are adjusted. Specifically, a graph d shows a gray scale-chromaticity characteristic at the color coordinate x, the gray scale-chromaticity characteristic being obtained in the mode in which two gate bus lines 2 are concurrently selected and the lookup table for the normal drive mode is used so that the gray scales of the respective pixels are subjected to no adjustment. A graph e shows a gray scale-chromaticity characteristic at the color coordinate x, the gray scale-chromaticity characteristic being obtained in a case where the gray scales of the respective pixels are adjusted by use of the lookup table for concurrently selecting two lines. In the graph e, a chromaticity at each gray scale is almost constant in a vicinity of 0.3×F. That is, it is shown that a higher gray scale-chromaticity characteristic is obtained in the graph e than in the graph d. Similarly, a graph f shows a gray scale-chromaticity characteristic at the color coordinate y, the gray scale-chromaticity characteristic obtained in a case where two gate bus lines 2 are concurrently selected and the lookup table for the normal drive mode is used so that gray scales in the respective pixels are subjected to no adjustment. A graph g shows a gray scale-chromaticity characteristic at the color coordinate y, the gray scale-chromaticity characteristic being obtained in a case where the gray scales of the respective pixels are adjusted by use of the lookup table for concurrently selecting two lines and two gate bus lines 2 are concurrently selected. In the graph g, a chromaticity at each gray scale is almost constant in a vicinity of 0.3×F. That is, it is shown that a higher gray scale-chromaticity characteristic is obtained in the graph g than in the graph f.

As described earlier, in a case where two gate bus lines are concurrently selected a higher gray scale-chromaticity characteristic can be obtained by selecting the lookup table for concurrently selecting two lines, and adjusting gray scales of respective pixels. Note that such a lookup table in which gray scales of respective pixels are stored can be recorded in ROM data also in Embodiment 2 as in the case of Embodiment 1. Note, also, that gray scales of respective pixels can be adjusted in accordance with how many gate bus lines 2 are concurrently selected.

### Supplementary Note

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

The present invention can also be described as below, for example.

1. A first drive parameter and a second drive parameter are recorded in ROM data. The first drive parameter is optimized for a ratio between bright and dark pixels in a normal drive mode, and the second drive parameter is optimized for a ratio between bright and dark pixels in a drive mode for concurrently selecting a plurality of lines. It is determined in accordance with a driving method which of the first drive parameter or the second drive parameter is used.

2. A γ adjusting parameter, a color balance adjustment parameter, and an overshoot parameter are mainly used as the drive parameters.

3. The number of lookup tables which are stored is not limited to two, and it is possible to switch between m lookup tables in accordance with a drive for concurrently selecting m lines.

### Preferable Embodiment of the Present Invention

The liquid crystal drive circuit of the present invention is preferably configured such that the drive parameter selecting means includes, as the drive parameter, a lookup table which specifies a relationship between a gray scale of input data and an output gray scale in accordance with the gray scale of the input data.

According to the configuration, the drive parameter selecting means includes, as the drive parameter, a lookup table which specifies a relationship between a gray scale of input data and an output gray scale in accordance with the gray scale of the input data. This brings about a further effect of easily finding the output gray scale based on the gray scale of the input data.

The liquid crystal drive circuit of the present invention is preferably configured such that the drive parameter selecting means of the liquid crystal driving circuit further includes a lookup table for adjusting of a gamma value.

According to the configuration, the drive parameter selecting means further includes the lookup table for adjusting of a gamma value. According to this, in a case where a gamma value needs to be adjusted, the drive parameter selecting means can select the lookup table for adjusting of a gamma value. This makes it possible to bring about a further effect such that, even in a case where a plurality of gate bus lines 2 are concurrently driven, a gamma value of an image displayed in a liquid crystal panel by the liquid crystal drive circuit can be close to a gamma value obtained in a case where the plurality of gate bus lines 2 are sequentially driven, i.e., in the case of the normal drive mode.

The liquid crystal drive circuit of the present invention is preferably configured such that the drive parameter selecting means of the liquid crystal driving circuit of the present invention further includes a lookup table for adjusting of a color balance.

According to the configuration, the drive parameter selecting means further includes the lookup table for adjusting of a color balance. According to this, in a case where a color balance needs to be adjusted, the drive parameter selecting means can select the lookup table for adjusting of a color balance. This makes it possible to bring about a further effect such that, even in a case where a plurality of gate bus lines 2 are concurrently driven, a color balance of an image displayed in a liquid crystal panel by the liquid crystal drive circuit can be close to a color balance obtained in a case where the plurality of gate bus lines 2 are sequentially driven, i.e., in the case of the normal drive mode.

The liquid crystal drive circuit of the present invention is preferably configured such that the drive parameter selecting means of the liquid crystal driving circuit of the present invention further includes a lookup table for adjusting of an overshoot value.

According to the configuration, the drive parameter selecting means further includes the lookup table for adjusting of an overshoot value. According to this, in a case where an overshoot value needs to be adjusted, the drive parameter selecting means can select this lookup table for adjusting of an overshoot value. This brings about a further effect of improving a response characteristic of a liquid crystal panel driven by the liquid crystal drive circuit, irrespectively of how many gate bus lines are concurrently driven.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided that such variations do not exceed the scope of the patent claims set forth below.

### INDUSTRIAL APPLICABILITY

A liquid crystal driving circuit of the present invention, a liquid crystal display device of the present invention including the liquid crystal driving circuit, and a method of the present invention for driving the liquid crystal driving circuit can be widely applied to general display devices including a liquid crystal display device using a liquid crystal display panel.

### REFERENCE SIGNS LIST

1: liquid crystal driving circuit
2: gate bus line
4: source bus line
6: storage capacitor bus line
8: first TFT
10: second TFT
12: third TFT
14: gate bus line driving circuit (gate bus line driving means)
16: drive parameter selecting section (drive parameter selecting means)
18: source bus line driving circuit (source bus line driving means)
20: sub pixel
22: sub pixel
24: sub pixel
26: sub pixel

1. A liquid crystal drive circuit for driving a liquid crystal display device substrate, comprising:
a plurality of gate bus lines provided so as to be juxtaposed to each other on a substrate;
a plurality of source bus lines provided so as to intersect with the plurality of gate bus lines via an insulating film;
a plurality of storage capacitor bus lines provided so as to be juxtaposed to the respective plurality of gate bus lines;
each pixel region, in which a first sub pixel having a first pixel electrode and a second sub pixel having a second pixel electrode are provided and which is specified by one source bus line and one gate bus line, including:
a first transistor, having (a) a gate electrode electrically connected to the one gate bus line, (b) a source electrode electrically connected to the one source bus line, and (c) a drain electrode electrically connected to the first pixel electrode,
a second transistor, having (a′) a gate electrode electrically connected to the one gate bus line, (b′) a source electrode electrically connected to the one source bus line, and (c′) a drain electrode electrically connected to the second pixel electrode which is electrically isolated from the first pixel electrode;
a third transistor, having (a″) a gate electrode electrically connected to another gate bus line provided next to the one gate bus line and (b″) a drain electrode electrically connected to the second pixel electrode;
a buffer capacitor section, having (a″′) a first buffer capacitor electrode electrically connected to a storage capacitor bus line and (b″′) a second buffer capacitor electrode provided so as to face the first buffer capacitor electrode via the insulating film and electrically connected to a source electrode of the third transistor;
gate bus line driving means for driving the plurality of gate bus lines;
drive parameter selecting means for selecting, in accordance with how many gate bus lines of the plurality of gate bus lines are concurrently driven by the gate bus line driving means, a drive parameter optimized for a ratio between bright and dark pixels which ratio is determined in accordance with how many gate bus lines of the plurality of gate bus lines are concurrently driven by the gate bus line driving means; and
source bus line driving means for driving the plurality of source bus lines by use of the drive parameter thus selected by the drive parameter selecting means.

2. The liquid crystal drive circuit as set forth in claim 1, wherein the drive parameter selecting means includes, as the drive parameter, a lookup table which specifies a relationship between a gray scale of input data and an output gray scale in accordance with the gray scale of the input data.

3. The liquid crystal drive circuit as set forth in claim 2, wherein the drive parameter selecting means further includes a lookup table for adjusting of a gamma value.

4. The liquid crystal drive circuit as set forth in claim 2, wherein the drive parameter selecting means further includes a lookup table for adjusting of a color balance.

5. The liquid crystal drive circuit as set forth in claim 2, wherein the drive parameter selecting means further includes a lookup table for adjusting of an overshoot value.

6. A liquid crystal display device comprising a liquid crystal drive circuit as set forth in claim 1.

7. A method for driving a liquid crystal drive circuit for driving a liquid crystal display device substrate, including:
a plurality of gate bus lines provided so as to be juxtaposed to each other on a substrate;
a plurality of source bus lines provided so as to intersect with the plurality of gate bus lines, via an insulating film;
a plurality of storage capacitor bus lines provided so as to be juxtaposed to the respective plurality of gate bus lines;
each pixel region, in which a first sub pixel having a first pixel electrode and a second sub pixel having a second pixel electrode are provided and which is specified by one source bus line and one gate bus line, including:
a first transistor, having (a) a gate electrode electrically connected to the one gate bus line, (b) a source electrode electrically connected to the one source bus line, and (c) a drain electrode electrically connected to the first pixel electrode,
a second transistor, having (a′) a gate electrode electrically connected to the one gate bus line, (b′) a source electrode electrically connected to the one source bus line, and (c′) a drain electrode electrically connected to the second pixel electrode which is electrically isolated from the first pixel electrode;
a third transistor, having (a″) a gate electrode electrically connected to another gate bus line provided next to the one gate bus line and (b″) a drain electrode electrically connected to the second pixel electrode; and
a buffer capacitor section, having (a″) a first buffer capacitor electrode electrically connected to a storage capacitor bus line and (b″) a second buffer capacitor electrode provided so as to face the first buffer capacitor electrode via the insulating film and electrically connected to a source electrode of the third transistor,
said method comprising the steps of:
(i) driving the plurality of gate bus lines;
(ii) selecting, in accordance with how many gate bus lines of the plurality of gate bus lines are concurrently driven in the step (i), a drive parameter optimized for a ratio between bright and dark pixels which ratio is determined in accordance with how many gate bus lines of the plurality of gate bus lines are concurrently driven in the step (i); and
(iii) driving the plurality of source bus lines by use of the drive parameter thus selected in the step (ii).
